(19) United States
(12) Patent Application Publication
(10) Pub. No.: US 2020/0364592 A1
(43) Pub. Date: Nov. 19, 2020

(54) ESTIMATING CONCENTRATION OF A SUBSTANCE

(71) Applicant: Liverpool John Moores University, Liverpool (GB)

(72) Inventors: Andrew Shaw, Liverpool (GB); Patryk Kot, Liverpool (GB); Magomed Muradov, Liverpool (GB); Samuel Ryecroft, Liverpool (GB)

(21) Appl. No.: 16/410,081

(22) Filed: May 13, 2019

(51) Int. Cl. G06N 5/04; G06N 20/00; G06F 1/16

(52) U.S. Cl. CPC G06N 5/046; G06F 1/1601; G06N 20/00

(57) ABSTRACT

A method and device for estimating concentration of a substance that transmits an output signal having a frequency retrieved from a store storing a plurality of frequencies, and receives a reflected power signal based on the output signal being reflected from a surface. The method/device processes data representing the reflected power signal using a plurality of prediction models to estimate a concentration of the substance on the surface, and generates an output representing the estimated concentration of the substance.

### BACKGROUND OF THE INVENTION

The present invention relates to estimating concentration of a substance.

There are many situations where it is desirable to determine whether a substance is present on a surface, including estimating the concentration of the substance in a convenient manner.

One example situation is determining the concentration of insecticides. The control of insect vectors that transmit diseases including malaria, visceral leishmaniasis and zika rely on the use of insecticide. One method used in controlling the vectors is through indoor residual spraying, applying insecticide to the wall surface inside houses. Alphacypermethrin is one of the insecticides that is currently sprayed in several countries for vector control. QA forms an essential component of performance monitoring, including validation that the correct dose of insecticide is delivered in any vector control intervention. However, for many programmes performing QA is costly and logistically challenging and the approach is not used. For indoor residual spraying (IRS), the current gold standard method to quantify insecticide deposited is carrying out high performance liquid chromatography (HPLC) on filter papers that were affixed to walls prior to IRS. Together with surveys monitoring insecticide efficacy and the residual decay rate, this provides a comprehensive understanding of the operational impact of IRS. However, these methods can be time consuming and require insectaries with susceptible colonies, laboratories, expensive equipment and skilled technicians. Furthermore, IRS operators can become sensitised to QA methods used and focus spray efforts on filter papers, providing artificial results.

### SUMMARY OF THE INVENTION

Embodiments of the present invention aim to address at least one of the above problems. Embodiments can provide a device that can estimate concentration of a substance in a contactless, non-destructive, fast and convenient manner.

According to one aspect of the present invention there is provided a device configured to estimate a concentration of a substance, the device comprising:

a transceiver;

a storage configured to store:
data representing a plurality of frequencies, and
a plurality of prediction models, and

a processor configured to:
control the transceiver to transmit an output signal having one of the plurality of frequencies;
receive, from the transceiver, a reflected power signal based on the output signal being reflected from a surface;
process data representing the reflected power signal using the plurality of prediction models to estimate a concentration of the substance on the surface, and
generate an output representing the estimated concentration of the substance.

The plurality of prediction models may comprise a plurality of trained Machine Learning models. Each of the trained Machine Learning models may comprise a plurality of classifications. Each of the classifications may represent a specific concentration or range of concentrations of the substance. In some embodiments the trained Machine Learning models may comprise Random Forest (RF), K-Nearest Neighbour (KNN), Support Vector Machine (SVM) and Gradient Boosted Model (GBM).

The processor may be configured to process the data representing the reflected power signal to determine a fit to one of the plurality of classifications. The processor may compare the data representing the reflected power signal to boundaries of the trained Machine Learning models.

The processor may be configured to determine a final classification to be output based on outputs of two or more of the prediction models. For example, the processor may determine the final classification based on a majority rule, weight predictions based on performance of the trained Machine Learning models from which boundaries were extracted, and/or weighting predictions on a scale.

Each of the plurality of frequencies may be determined to be indicative of a specific concentration of a substance, e.g. determined by a frequency identification process that identifies frequencies that are indicators of presence and concentration of the substance. The frequency identification process may comprise a plurality of wrapper feature selection processes that identify frequencies useable to identify a prediction strength of frequencies. In some embodiments the plurality of wrapper feature selection processes may comprise a plurality of machine learning algorithms including Random Forest (RF), K-Nearest Neighbour (KNN), Support Vector Machine (SVM) and Gradient Boosted Model (GBM). The frequency identification process may further rank an importance of each of the frequencies within each of the wrapper feature selection processes to identify a subset of the frequencies that are the best predictors for the wrapper feature selection process.

The trained Machine Learning models may be created using the plurality of wrapper feature selection processes on previous data relating to concentration determination of the substance. The previous data may be processed using a normalization process, an information gain filter and/or a ranking process.

The processor may be configured to repeat its processing for at least some of the frequencies of the plurality of frequencies.

The transceiver, storage and processor may be included in a housing. The housing may form a main body of the device. The device may further comprise a display. The output may be indicated on the display, e.g. as one of a set of coloured lights. The output may be stored/transmitted for further processing by another device.

According to another aspect of the present invention there is a method of estimating concentration of a substance, the method comprising or including:

transmitting an output signal having a frequency from a plurality of stored frequencies;

receiving a reflected power signal based on the output signal being reflected from a surface;

processing data representing the reflected power signal using a plurality of prediction models to estimate a concentration of the substance on the surface, and generating an output representing the estimated concentration of the substance.

According to yet another aspect of the present invention there is provided a client/server implementation of methods substantially as described herein.

According to another aspect of the present invention there is provided a computing device including, or in communication with, apparatus substantially as described herein.

According to another aspect of the present invention there is provided a computer readable medium storing a computer program to operate a method substantially as described herein.

According to the present invention, there is provided a method, an apparatus and a system as set forth in the appended claims. Other features of the invention will be apparent form the dependent claims, and the description which follows.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 is a schematic diagram of an example device configured to estimate concentration of a substance;

FIG. 2 schematically illustrates examples of operations performed by the device to estimate concentration of a substance, and

FIG. 3 schematically illustrates examples of operations performed during a process for identifying frequencies to be output by the device.

### DETAILED DESCRIPTION OF THE INVENTION

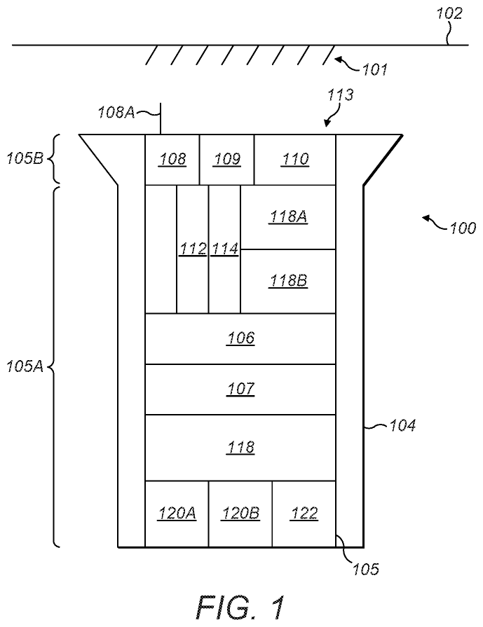

FIG. 1 shows an example device 100 that is configured to estimate concentration of a substance (schematically illustrated at 101) on a surface 102. The device comprises a housing 104. It will be appreciated that the design, dimensions and material(s) used for the housing can vary. In general, the housing can include a handle portion 105A that is suitable for being held by a human user and a transceiver housing portion 105B at one end that contains at least the transceiver components as described below. The handle portion may be generally cuboid or cylindrical in shape, for example, and may be formed from a lightweight but rigid material, such as a suitable plastic, metal or alloy. The housing may include formations (not shown) that facilitates grip and/or may be at least partially covered by a material, such as rubber, that facilitates grip.

The housing 104 contains at least some of the components of the device 100. The components can comprise a circuit 105 that includes a processor/microcontroller 106 that is used to interact with and control various features of the device, as well as a storage device 107, e.g. a non-volatile memory. The circuit can further comprise a transceiver 113. In some embodiments the transceiver can comprise an antenna 108A that is connected to a voltage-controlled oscillator (VCO) 108 and an RF power detector 110; however, it will be understood that in alternative embodiments the transceiver can be implemented by means of one or more different component(s). An RF coupler 109 can link the antenna output/voltage-controlled oscillator and the RF power detector together, allowing the output of the voltage-controlled oscillator to pass through to the connected antenna so that reflected power (of the output RF signal that is reflected from the surface 102) received through the antenna can be fed into the RF power detector. The RF power detector can be used to detect the reflected power of the RF signal detected by the antenna and provide fundamental values by which predictions of substance concentration are made by the device. The circuit design can be built on the output of a frequency identification process (described below) that identifies the correct RF frequencies at which the device should operate.

The circuit 105 can include a high precision analogue to digital converter (ADC) 112 that connects to the output of the RF power detector 110 and interfaces with the microcontroller 106 to give a high precision digital interpretation of the analogue output power detector. The circuit can further include a Digital to Analogue converter (DAC) 114 which can be used by the microcontroller 106 to tune the voltage-controlled oscillator 108 to the desired frequencies. The circuit may further comprise at least one sensor, such as a temperature sensor 118A and a humidity sensor 118B connected to the microcontroller and which can provide a humidity and temperature for a power reading that is being taken. This information can be used in conjunction with power readings to adjust for environmental factors.

The circuit 105 may further comprise components for communicating with external device(s)/network(s). In some embodiments the device 100 can include a Bluetooth™ module 120A that Interfaces with the microcontroller 106 to allow external Bluetooth™ enabled devices to collect data and/or perform device configuration, e.g. adjusting sensor configuration parameters such as thresholds and possibly providing the option to allow for over the air firmware updates. Additionally or alternatively, the device may comprise an interface 120B for a removable storage device, such as an SD card, for performing at least some of these operations. The SD card can allow data collected during the sensors operation to be collected and stored ready for further analysis later to improve and develop the detection strategy.

It will be appreciated that embodiments of the device 100 can include various other features, e.g. an output device/display 118, a user interface/switch(es) 122, a power supply/source (such as a battery and/or mains/USB power input), a power on/off switch, etc. Such components are well-known to the skilled person and need not be described in detail. Further, one or more of the specific example components (or their function(s)) may be omitted, replaced and/or combined.

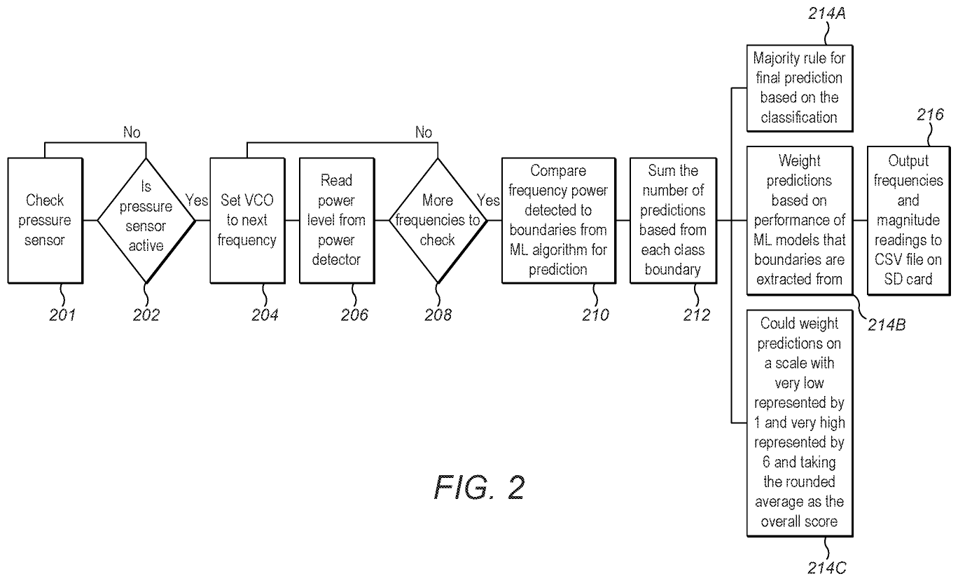

FIG. 2 illustrates examples of steps typically performed by the microprocessor 106 of the device 100 in order to estimate the concentration of a substance present on a surface. First, the operation of the device is activated and initiated ready to perform readings. In some embodiments this can comprise sensing whether a pressure sensor (e.g. functioning as an on button) has been activated at steps 201-202. The initialisation can comprise reading a frequency data set from the storage 107 that represents a set of frequencies that is to be output by the device. The frequencies will typically be in the Radio Frequency band, e.g. around 100 MHz to 6 GHz, and in some specific cases frequencies in the microwave band, but alternatives are possible.

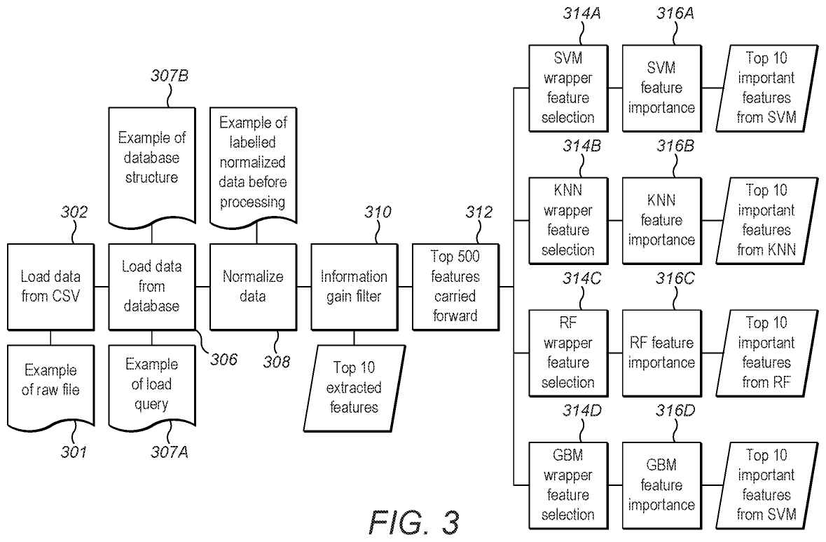

FIG. 3 and the associated description below provide an example of how the frequency data can be generated. In some embodiments the data analysis performed by the device is based on laboratory-based data collection that used a vector network analyser (VNA) to collect samples of substance concentrations which were then analysed using a frequency identification process. Some embodiments use the techniques disclosed in Patryk Kot, Magomed Muradov, Samuel Ryecroft, Montserrat Ortoneda Pedrola, Andy Shaw, BEST Research Institute, Liverpool John Moores University: “Identification of Optimal Frequencies to DetermineAlpha-Cypermethrin using Machine Learning Feature Selection Techniques”; 2018 IEEE Congress on Evolutionary Computation (CEC), pages 1-7 (the contents of which is hereby incorporated by reference) to generate some of the data stored in the storage 107. In one specific example, each collected data point comprised 4000 readings taken at regular frequency intervals.

The storage 107 of the device 100 can also store a calibration set/prediction models that are used for determining the presence/concentration of a target substance, e.g. insecticide, based on one or more reading. The prediction models can comprise a plurality of Machine Learning prediction models, such as a trained model based on previous data. The storage of the device can comprise an algorithm/instructions (as shown in FIG. 2, for example) that utilises the prediction models and data based on the readings to make a concentration estimation onboard the device.

The device 100 may be configured with the prediction models at manufacture. Alternatively, the device may be provided with alternative and/or updated prediction model(s), e.g. by transferring data from an SD card to the internal memory 107 of the device. Further, the device may store/be provided with a plurality of sets of prediction models, each set intended for use in estimating concentration of a particular, different substance. A particular one of the plurality of sets may be selectable via a user-interface on the device, for example.

At step 204 the microcontroller 106 can tune the DAC 114 to output the correct voltage for the transceiver 113/VCO 108 to output a signal having a particular frequency included in the frequency data set.

At step 206 the microcontroller 106 takes a reading from the power detector 110 for the power level that is detected at the output frequency. A user typically directs the transceiver housing portion 105B of the device 100 towards the wall 101 whilst device it outputting the signal and so the reading will be based on a reflected power signal (of the output signal) that is reflected from the surface. In some embodiments the device may take a reading from at least one additional sensor (e.g. the temperature sensor 118A and/or the humidity sensor 118B) substantially simultaneously with the power signal reading.

An example of data that can be collected by the device 100 based on a series of readings of the signals, with V_tune representing the tuning voltage used, magnitude representing the power detected back and the temperature and humidity sensed, is shown in the table below:

| V_tune | Mag | Temp | Humid |
|---|---|---|---|
| 0.002518 | 1.530268 | 33.41 | 30.07 |
| 0.005035 | 1.509457 | 33.41 | 30.07 |
| 0.007553 | 1.50286 | 33.41 | 30.07 |
| 0.010071 | 1.507136 | 33.41 | 30.07 |
| 0.012589 | 1.617735 | 33.41 | 30.07 |
| 0.015106 | 1.614902 | 33.41 | 30.07 |
| 0.017624 | 1.493484 | 33.41 | 30.07 |
| 0.020142 | 1.490735 | 33.41 | 30.07 |
| 0.022659 | 1.495107 | 33.41 | 30.07 |
| 0.025177 | 1.496564 | 33.41 | 30.07 |

It will be appreciated that the number, types and formats of data can be varied. In some embodiments, additional information can be associated with each reading, or with a batch of two or more readings. For example, the additional data may include a time/date stamp; information regarding the surface/location (e.g. a code input by a user, or obtained from a local or remote Global Positioning System sensor), and so on.

At step 208, embodiments can check whether there are any further frequencies in the frequency data set that are to be output for further readings to be taken. If so then the steps 204 and 206 can be repeated for the remaining frequency/frequencies.

At step 210 data based on the reading (or batch of readings) is passed by the microcontroller 106 through the prediction models in the storage 107 to obtain estimates of the concentration of the substance. In some embodiments, the concentration estimation may be based on a plurality of predicted classes for each of the implemented models. That is, an estimated concentration may be determined to be in one of a plurality of classifications. In some embodiments the classifications can comprise the following five classes: Extremely low; Low; Correct (25 mg/m²); High; Extremely high. However, it will be understood that the number and specifications of the classifications can vary; for instance, a numerical range may be used rather than a descriptor, e.g. three distinct classes: 25 mg/m², 400 mg/m² and 425 mg/m².

The reading data processed in relation to each prediction model typically comprises the frequency, magnitude and phase of the sweep conducted. Each of these values can be inputted into the algorithms/prediction models that have been specifically created for the environment/calibration set in which the sensor is working. The algorithm and the calculation can be performed on the device with the outcome being displayed on its indication system/display. In other embodiments the readings may, additionally or alternatively, be stored/transferred for remote processing/output. Each of the prediction models can generate an output (typically a numerical value) representing a probability of the reading falling into a predicted concentration class. In some embodiments at the step 210 the device 100 may compare frequency power detected to boundaries from the ML algorithms for prediction. Each of the classifications can represent a range of concentration of the substance, e.g. 22.5 mg/m³ to 25 mg/m³, which can define the resolution/sensitivity of the device.

At step 212 in some embodiments the microcontroller 106 collects the predictions generated at the step 210 so that the most common predicted class can be output. In some embodiments the step 212 can comprise summing the number of predictions based on each class boundary.

Following the step 212, in some embodiments the device 100 may use one (or more) of a plurality of techniques to determine a final output that is to be generated. In some embodiments the device can combine several prediction strategies to create a majority rule system, or the like, that combines the pre-trained machine learning models used in the wrapper feature selection processes to classify the predicted concentration class of the reading(s) taken, using the data collected through the RF sensor and combining it with the temperature and humidity data for each of the classification models. Temperature and humidity data can be used to normalise the data received from the sensor before thresholds are implemented.

Examples of these techniques are shown in steps 214A-214C; however, it will be appreciated that the number and types of techniques can be varied. The example embodiment of FIG. 2 uses three different techniques to compare with the calibration set and then a final two from the three techniques can be used to determine the correct response. The algorithm can be adaptive to take into account the environmental conditions in which the device is operating so as to give a more accurate reading. This would therefore be a normalised calibration set determined from relative humidity and temperature. Step 214A comprises a technique involving majority rule for final prediction based on the classifications' weight predictions. Step 214B comprises weight predictions based on performance of ML models from which boundaries are extracted. Step 214C comprises weighting predictions on a scale, with very low represented by 1 and very high represented by 6 and taking the rounded average as the overall score.

The device 100 can produce an output representing the predicted class determined at the step 214, which indicates the estimated concentration of the substance 101 on the surface 102. The output may, for example, be transmitted though the Bluetooth™ connection, and/or use using an LED traffic light system on the display of the device itself.

Optionally, at step 216 the device may output frequencies and magnitude readings to an external device, e.g. as a .CSV file or strings onto an SD card. The output can include codes representing location, time, date, predicted classification, etc, of the readings. The output may be used to further train the prediction models.

FIG. 3 shows examples of steps performed in order to identify frequencies that are to be used by the device 100 for estimating concentration of a substance. The steps may be performed by a VNA in combination with a desktop computer or the like. Some embodiments use a Rohde and Schwarz ZVL13 VNA for capturing spectral data from an electromagnetic horn antenna, with the computer automating the process via a bespoke National Instruments LabVIEW interface. The identification approach undertaken may use a wrapper feature selection process to identify frequencies that are the strongest indicators of the presence and concentration of a substance, such as an insecticide, e.g. alpha-cypermethrin.

At step 302 raw data (e.g. in the form of a .CSV spreadsheet 301) collected from the VNA is input. For example embodiments intended to determine insecticide concentration, the data typically comprises the frequency as well as the VNA's response, including real and imaginary components, magnitude and phase. A truncated example of the content of this input data is shown in the table below:

| Freq | Mag | Real | Imaginary | Phase |
|---|---|---|---|---|
| 1000000000 | 0.44308 | 0.70783 | 0.636227 | 137.983 |
| 1001250304 | 0.47267 | 0.69839 | 0.643065 | 137.8427 |
| 1002500608 | 0.42241 | 0.69535 | 0.648388 | 137.0681 |
| 1003750912 | 0.45747 | −0.6895 | 0.65334 | 136.7039 |
| 1005001280 | 0.44056 | 0.67466 | 0.665533 | 135.2637 |
| 1006251584 | −0.5757 | 0.65511 | 0.676578 | 134.0024 |
| 1007501888 | 0.49597 | 0.6455 | 0.682724 | 133.5652 |
| 1008752192 | 0.41959 | 0.65023 | 0.695495 | 132.9948 |
| 1010002496 | 0.59214 | 0.62769 | 0.682979 | 132.6931 |

At step 306, the data is loaded for use in a database. An example of a select query 307A used to extract data is given below; however, it will be understood that many variations (e.g. not using SQL) are possible:

SELECT frequency, magnitude, treatment_applied, file_id FROM raw_vna_readings;

An example of a data definition language statement 307B for creating the database, which is used to store data that is collected is:

CREATE TABLE raw_vna_readings (

‘file_id‘ int auto_increment,
‘treatment_applied‘ boolean,
‘class‘ int,
‘rep int‘,
‘magnitude‘ real,
‘frequency‘ real,
primary key (‘file_id‘)
)

At step 308, the data is cleansed by applying a normalisation approach to ensure that the magnitude of values do not impact the features selected by the selection process. An example of the transformed data into a wide format for feature selection (reduced size) is given in the table below, with each row representing one reading file:

| Class | Rep | 1000000000 | 1003000768 | . . . | 12999999488 |
|---|---|---|---|---|---|
| 0 | 1 | −64.15831 | −68.792221 | . . . | −10.824662 |
| 0 | 2 | −73.290466 | −57.421055 | . . . | −12.386813 |
| 0 | 3 | −70.715958 | −69.105598 | . . . | −13.103442 |
| 0 | 4 | −60.759758 | −58.502308 | . . . | −12.1321 |
| 0 | 5 | −59.46563 | −62.251072 | . . . | −11.242316 |
| 0 | 6 | −67.477737 | −58.719128 | . . . | −11.668687 |
| 0 | 7 | −59.841293 | −61.040752 | . . . | −11.743226 |
| 0 | 8 | −74.769798 | −66.965134 | . . . | −11.944211 |
| 0 | 9 | −59.622662 | −65.55127 | . . . | −11.761778 |
| 0 | 10 | −63.33427 | −56.926338 | . . . | −12.555132 |

At step 310, an information gain filter is applied to the data. To reduce the feature space the process can use a simple information gain filter to remove a significant number of features. Information gain can provide a quick and efficient approach to identification of features that are not strong indicators of an outcome by looking at 65 the mutual information that a single feature holds.

An example of the results of applying the information gain filter with each feature within the wide data set shown above being given a ranking is shown in the table below:

| Rep | 0 |
|---|---|
| 1E+09 | 0.148355 |
| 1E+09 | 0.122966 |
| 1E+09 | 0.110627 |
| 1E+09 | 0.112347 |
| 1.01E+09 | 0.094393 |
| 1.01E+09 | 0.104308 |
| 1.01E+09 | 0.082944 |
| 1.01E+09 | 0.089651 |
| 1.01E+09 | 0.08876 |

An example of the features extracted from the information gain filter ranked in order of importance is shown in the table below:

| Rank | Frequency |
|---|---|
| 1 | 4904726016 |
| 2 | 4902225408 |
| 3 | 4903475712 |
| 4 | 4907226624 |
| 5 | 4797199360 |
| 6 | 4905976320 |
| 7 | 4899724800 |
| 8 | 4795949056 |
| 9 | 4900975104 |
| 10 | 4488372224 |

At step 312, a number of the features are selected for further processing by the method. In some embodiments the top 500 ranking features are selected; however, it will be appreciated that this number can vary.

In some embodiments the next stage in the process uses a plurality of wrapper feature selection processes (steps 314) to identify features that can be used to identify the prediction strength of the features remaining after the information gain filter. In some embodiments the reduced feature space can be passed through a plurality of machine learning algorithms, e.g. Random Forest (RF), K-Nearest Neighbour (KNN), Support Vector Machine (SVM) and Gradient Boosted Model (GBM). However, the skilled person will understand that in alternative embodiments different and/or additional ML algorithms could be used. Features can then (steps 316) be ranked on their importance within each of the models to identify a subset of the features that are the best predictors for their individual model. In the example embodiment of FIG. 3, the top 10 highest ranked features for each prediction model are selected; however, it will be appreciated that the number can vary and/or may differ across the models.

In the illustrated example, SVM wrapper feature selection is performed at step 314A, followed at step 316A by selecting the top 10 SVM features by importance. The SVM is a linear model for classification and regression. The SVM algorithm creates a line or a hyperplane which separates the data into classes.

An example of the ranked features retrieved from the SVM algorithm frequencies and the percentage of prediction accuracy for each class used is shown the table below:

| | Class | Class | Class | Class | Class |
|---|---|---|---|---|---|
| Frequency | 1 | 2 | 3 | 4 | 5 |
| 4699675136 | 79.16 | 79.16 | 79.16 | 100.00 | 47.46 |
| 4583395840 | 90.58 | 90.58 | 96.14 | 100.00 | 69.03 |
| 4582145536 | 86.19 | 86.19 | 92.31 | 100.00 | 65.31 |
| 4477119488 | 89.07 | 89.07 | 96.71 | 100.00 | 59.14 |
| 5256064000 | 75.50 | 75.50 | 81.43 | 100.00 | 73.27 |
| 3990747648 | 87.34 | 87.34 | 94.58 | 100.00 | 59.43 |
| 5372343296 | 58.05 | 79.62 | 69.65 | 100.00 | 79.62 |
| 5369842688 | 82.65 | 78.37 | 72.53 | 100.00 | 82.65 |
| 5252313088 | 78.79 | 74.29 | 80.08 | 100.00 | 78.79 |

In the illustrated example, KNN wrapper feature selection is performed at step 314B, followed at step 316B by selecting the top 10 KNN features by importance.

An example of the ranked features retrieved from the KNN algorithm frequencies and the percentage of prediction accuracy for each class used is given in the table below:

| | Class | Class | Class | Class | Class |
|---|---|---|---|---|---|
| Frequency | 1 | 2 | 3 | 4 | 5 |
| 4699675136 | 79.16 | 79.16 | 79.16 | 100.00 | 47.46 |
| 5369842688 | 82.65 | 78.37 | 72.53 | 100.00 | 82.65 |
| 4477119488 | 89.07 | 89.07 | 96.71 | 100.00 | 59.14 |
| 3990747648 | 87.34 | 87.34 | 94.58 | 100.00 | 59.43 |
| 5372343296 | 58.05 | 79.62 | 69.65 | 100.00 | 79.62 |
| 4583395840 | 90.58 | 90.58 | 96.14 | 100.00 | 69.03 |
| 4582145536 | 86.19 | 86.19 | 92.31 | 100.00 | 65.31 |
| 5256064000 | 75.50 | 75.50 | 81.43 | 100.00 | 73.27 |
| 5253563392 | 78.29 | 78.29 | 84.75 | 100.00 | 73.29 |

In the illustrated example, RF wrapper feature selection is performed at step 314C, followed at step 316B by selecting the top 10 RF features by importance.

An example of the ranked features retrieved form the RF algorithm with an overall weighting given is given in the table below:

| Frequency | Weighting |
|---|---|
| ‘2762940672’ | 100 |
| ‘2764190976’ | 96.75 |
| ‘2996749312’ | 78.71 |
| ‘2999249920’ | 74.91 |
| ‘2995498752’ | 72.04 |
| ‘5363590656’ | 71.33 |
| ‘2765441280’ | 69.58 |
| ‘2761690368’ | 64.43 |
| ‘2760440064’ | 63.65 |

In the illustrated example, GBM wrapper feature selection is performed at step 314D, followed at step 316D by selecting the top 10 GBM features by importance.

An example of the ranked features retrieved form the GBM algorithm with an overall weighting given is given in the table below:

| Frequency | Weighting |
|---|---|
| ‘5828707328’ | 100.000 |
| ‘2996749312’ | 87.857 |
| ‘2999249920’ | 31.704 |
| ‘2995498752’ | 29.817 |
| ‘2997999616’ | 29.393 |
| ‘4803450880’ | 28.981 |
| ‘4805951488’ | 24.266 |
| ‘5363590656’ | 19.525 |
| ‘4897224192’ | 18.697 |

The top 10 features (where the Feature comprises the Best Frequency) for each model define the operational frequencies that will be used to provide the concentration thresholds of the measured substance. For example, for the SVM model, a top ten frequency, e.g. 4699675136 Hz, was identified as being one of the most useful for indicating that the concentration of the substance is in a particular concentration classification (e.g. Class 1). Similarly, the other nine of the top ten frequencies for the SVM model were identified as being most useful for indicating that the concentration of the substance is within one of the concentration classifications. Similarly, the top ten frequencies for the other models (KNN, RF, GBM) were identified as being useful for indicating that the concentration of the substance is within one of the concentration classifications. Data representing these models and frequencies can then be stored on the storage 107 of the device 100.

Although the embodiments detailed above relate to estimating concentration of Alphacypermethrin, it will be appreciated that this is exemplary only and alternative embodiments can be produced to estimate concentration of other substances. Alphacypermethrin is a synthetic pyrethoid, derived from the naturally occurring pyrethrins and embodiments can be produced to estimate concentration of such substances. Further, in general terms, embodiments may be produced to estimate concentration of any desired chemical, including neurotoxins, broad-spectrum insecticides or organochlorides, or combinations of these, on any building fabric.

It will be appreciated that the illustrated embodiment is exemplary only and that some of the processing and data used by embodiments may be distributed across several devices/locations and/or provided by cloud services or the like. The skilled person will further understand that the processes described herein can be implemented using any suitable programming language and data structures. Also, the sequences of steps illustrated in the flowcharts are exemplary only, and some may be re-ordered, omitted and/or performed concurrently. Further, additional steps (not illustrated) may also be performed in alternative embodiments.

It is understood that according to an exemplary embodiment, a computer readable medium storing a computer program to operate a method according to the foregoing embodiments is provided.

Attention is directed to any papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

We claim:

1. A device configured to estimate a concentration of a substance, the device comprising:
a transceiver;
a storage configured to store:
data representing a plurality of frequencies, and
a plurality of prediction models, and
a processor configured to:
control the transceiver to transmit an output signal having one of the plurality of frequencies;
receive, from the transceiver, a reflected power signal based on the output signal being reflected from a surface;
process data representing the reflected power signal using the plurality of prediction models to estimate a concentration of the substance on the surface, and
generate an output representing the estimated concentration of the substance.

2. A device according to claim 1, wherein the plurality of prediction models comprise a plurality of trained Machine Learning models providing a plurality of classifications, wherein each of the classifications represents a specific concentration, or range of concentrations, of the substance.

3. A device according to claim 2, wherein the trained Machine Learning models comprise Random Forest (RF), K-Nearest Neighbour (KNN), Support Vector Machine (SVM) and Gradient Boosted Model (GBM).

4. A device according to claim 3, wherein the processor is configured to process the data representing the reflected power signal to determine a fit to one of the plurality of classifications.

5. A device according to claim 4, wherein the processor is configured to determine a final classification to be output based on outputs of two or more of the prediction models.

6. A device according to claim 5, wherein the processor is configured to determine the final classification based on a majority rule, weight predictions based on performance of the prediction models from which boundaries were extracted, and/or weighting predictions of the prediction models on a scale.

7. A device according to claim 1, wherein each of the plurality of frequencies is determined to be indicative of a specific concentration of a substance by a frequency identification process that identifies frequencies that are indicators of presence and concentration of the substance.

8. A device according to claim 1, wherein the transceiver, the storage and the processor are included in a housing forming a main body of the device.

9. A device according to claim 1, further comprising a display, wherein the output is indicated on the display.

10. A method of estimating concentration of a substance, the method comprising:
transmitting an output signal having a frequency retrieved from a store storing a plurality of frequencies;
receiving a reflected power signal based on the output signal being reflected from a surface;
processing data representing the reflected power signal using a plurality of prediction models to estimate a concentration of the substance on the surface, and
generating an output representing the estimated concentration of the substance.

11. A method according to claim 10, wherein each of the plurality of frequencies is determined to be indicative of a specific concentration of a substance by a frequency identification process that identifies frequencies that are indicators of presence and concentration of the substance.

12. A method according to claim 11, wherein the frequency identification process comprises a plurality of wrapper feature selection processes.

13. A method according to claim 12, wherein the plurality of wrapper feature selection processes comprise a plurality of machine learning algorithms including Random Forest (RF), K-Nearest Neighbour (KNN), Support Vector Machine (SVM) and Gradient Boosted Model (GBM).

14. A method according to claim 13, wherein the frequency identification process further ranks an importance of each of the frequencies within each of the wrapper feature selection processes to identify a subset of the frequencies that are best predictors for the wrapper feature selection process.

15. A method according to claim 10, wherein the plurality of prediction models comprise a plurality of trained Machine Learning models created using a wrapper feature selection processes on previous data relating to determining concentration of the substance.
